(19) United States
(12) Patent Application Publication
(10) Pub. No.: US 2021/0155464 A1
(43) Pub. Date: May 27, 2021

(54) CONVEYANCE SYSTEM, CONVEYANCE METHOD, AND PROGRAM

(71) Applicant: TOYOTA JIDOSHA KABUSHIKI KAISHA, Toyota-shi (JP)

(72) Inventors: Tomohisa TAKAI, Nagoya-shi (JP); Yuhei YAMAGUCHI, Toyota-shi (JP); Satoshi TOYOSHIMA, Okazaki-shi (JP); Yuta WATANABE, Toyota-shi (JP); Tetsuya TAIRA, Nagakute-shi (JP); Mikio HONDA, Toyota-shi (JP); Shiro ODA, Anjyo-shi (JP); Nobuhisa OTSUKI, Toyota-shi (JP)

(73) Assignee: TOYOTA JIDOSHA KABUSHIKI KAISHA, Toyota-shi (JP)

(21) Appl. No.: 17/097,061

(22) Filed: Nov. 13, 2020

(30) Foreign Application Priority Data
Nov. 25, 2019 (JP) 2019-212380

(51) Int. Cl. B66F 9/06; B66F 9/075; B66F 9/12; G05D 1/00

(52) U.S. Cl. CPC B66F 9/063; G05D 1/0016; B66F 9/12; B66F 9/0755

(57) ABSTRACT

A conveyance system and the like capable of preferably conveying a conveyed object is provided. The conveyance system includes a conveyance robot, which is a conveyance apparatus, a drive controller, which is a controller, an information accepting unit, and a setting unit. The conveyance robot conveys the conveyed object. The drive controller controls an operation of the conveyance robot. The information accepting unit accepts an input from a user regarding information indicating stability of the conveyed object in a conveyance state. The setting unit sets an operation parameter of the conveyance apparatus in the drive controller based on the accepted information.

### CROSS REFERENCE TO RELATED APPLICATIONS

This application is based upon and claims the benefit of priority from Japanese patent application No. 2019-212380, filed on Nov. 25, 2019, the disclosure of which is incorporated herein in its entirety by reference.

### BACKGROUND

The present disclosure relates to a conveyance system, a conveyance method, and a program.

The development of autonomous moving apparatuses that autonomously move in certain buildings and facilities has been advancing. By equipping such an autonomous moving apparatus with a parcel carrier or towing a cart, it can be used as an automatic delivery apparatus that automatically delivers parcels. The automatic delivery apparatus can deliver, for example, a parcel loaded at a starting place to a destination by autonomously traveling from the starting point to the destination.

For example, an automatic delivery apparatus disclosed in U.S. Pat. No. 9,026,301 includes an autonomously movable tractor part and a parcel carrier part. Further, a computer provided in them stores electronic maps of floor plans of buildings and routes that the automatic delivery apparatus follows when it moves from one place to the next place. The above-described automatic delivery apparatus conveys various objects by using parcel carrier parts of different types depending on the purpose.

### SUMMARY

It is desired that a conveyance robot quickly convey a conveyed object. When the conveyed object is subjected to a vibration or an impact as a result of quickly conveying the conveyed object, however, it is possible that a problem such as collapse of the conveyed object may occur. Further, even when the kinds of conveyed objects are the same, if the state of the conveyed object is unstable, the above problem tends to occur easily. In the method of determining the stability of the conveyed object by detecting the centroid position of the conveyed object in the stationary state, however, it is impossible to determine whether or not the conveyance state is stable.

The present disclosure has been made in order to solve the above-described problem and provides a conveyance system and the like capable of preferably conveying conveyed objects.

A conveyance system according to one aspect of the present disclosure includes a conveyance apparatus, a controller, an information accepting unit, and a setting unit. The conveyance apparatus conveys a conveyed object. The controller controls an operation of the conveyance apparatus. The information accepting unit accepts an input from a user regarding information indicating stability of the conveyed object in a conveyance state. The setting unit sets an operation parameter of the conveyance apparatus in the controller based on the accepted information.

With the aforementioned configuration, the conveyance system is able to set the operation parameter associated with the stability at the time of conveyance in accordance with the input from the user. It is therefore possible to preferably convey the conveyed object regardless of the state of the conveyed object which is in the stationary state.

In the aforementioned conveyance system, the information accepting unit may present options for causing a user to select the stability and accept the option selected by the user as an input. The user is therefore able to easily input the stability information.

In the aforementioned conveyance system, the conveyance apparatus may be a conveyance robot that autonomously moves in a predetermined area. Thus the conveyance system is able to control the operation of the conveyance robot.

In the aforementioned conveyance system, the setting unit may set at least one of a moving acceleration of the conveyance robot and a moving path along which the conveyance robot passes as the operation parameter. With this configuration, the conveyance robot is able to reduce an external force that the conveyed object receives.

In the aforementioned conveyance system, the above conveyance robot may include an object sensor configured to detect an object that is present in the vicinity of the conveyance robot, and the setting unit may set a range detected by the object sensor as the operation parameter. Accordingly, the conveyance system is able to prevent a situation in which an obstacle unexpectedly contacts the conveyance robot and to prevent collapse of the conveyed object and the like.

In the aforementioned conveyance system, the above conveyance robot may include a notification apparatus that sends a notification indicating that the conveyance robot is conveying the conveyed object to an area in the vicinity of the conveyance robot and the setting unit may set a notification level of the notification apparatus as the operation parameter. Accordingly, the conveyance system is able to prevent a situation in which an obstacle unexpectedly contacts the conveyance robot and to prevent collapse of the conveyed object and the like.

In the aforementioned conveyance system, the above conveyance robot may include a raising/lowering mechanism for raising and/or lowering a wagon that accommodates the conveyed object, and the setting unit may set a raising/lowering acceleration of the raising/lowering mechanism as the operation parameter. Accordingly, the conveyance system is able to prevent collapse of the conveyed object and the like in the raising/lowering operation.

In the aforementioned conveyance system, the information accepting unit may be provided in the above wagon and the above wagon may transmit the accepted information to the setting unit. Accordingly, the conveyance system is able to input information for each wagon, which makes it easy for the user to perform the operation.

In the aforementioned conveyance system, the conveyance apparatus may be an elevator that raises and/or lowers a conveyance robot that conveys the conveyed object by an autonomous movement in a predetermined area, and the setting unit may set a moving acceleration of the elevator as the operation parameter. Accordingly, the conveyance system is able to comprehensively and preferably convey the conveyed object.

A conveyance method according to one aspect of the present disclosure is a control method for controlling an operation of a driving apparatus for conveying a conveyed object, and the method includes an information accepting step, a setting step, and a control step. The information accepting step accepts an input from a user regarding information indicating stability of the conveyed object in a conveyance state. The setting step sets an operation parameter of the driving apparatus based on the accepted information. The control step controls the conveyance apparatus by the set operation parameter.

With the aforementioned configuration, the conveyance method is able to set the operation parameter associated with the stability at the time of conveyance in accordance with the input from the user. Therefore, it is possible to preferably convey the conveyed object regardless of the state of the conveyed object which is in the stationary state.

A program according to one aspect of the present disclosure is a program for causing a computer to execute a control method for controlling an operation of a driving apparatus for conveying a conveyed object, and includes an information accepting step, a setting step, and a control step. The information accepting step accepts an input from a user regarding information indicating stability of the conveyed object in a conveyance state. The setting step sets an operation parameter of the driving apparatus based on the accepted information. The control step controls the conveyance apparatus by the set operation parameter.

With the aforementioned configuration, the program is able to set the operation parameter associated with the stability at the time of conveyance in accordance with the input from the user. Therefore, it is possible to preferably convey the conveyed object regardless of the state of the conveyed object which is in the stationary state.

According to the present disclosure, it is possible to provide a conveyance system and the like capable of preferably conveying conveyed objects.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is an overview diagram of a conveyance system according to a first embodiment;

FIG. 2 is a block diagram of the conveyance system according to the first embodiment;

FIG. 3 is a first diagram showing an example in which the conveyance system is used;

FIG. 4 is a second diagram showing an example in which the conveyance system is used;

FIG. 5 is a third diagram showing an example in which the conveyance system is used;

FIG. 6 is a fourth diagram showing an example in which the conveyance system is used;

FIG. 7 is a table showing an example of a database regarding stability;

FIG. 8 is a flowchart showing processing of the conveyance system;

FIG. 9 is a first diagram showing an example of an operation screen of an operation apparatus;

FIG. 10 is a second diagram showing an example of the operation screen of the operation apparatus;

FIG. 11 is a third diagram showing an example of the operation screen of the operation apparatus;

FIG. 12 is a block diagram of a conveyance system according to a second embodiment; and

FIG. 13 is a table showing an example of a stability database according to the second embodiment.

### DESCRIPTION OF EMBODIMENTS

Hereinafter, the present disclosure will be explained through embodiments of the present disclosure. However, they are not intended to limit the scope of the present disclosure according to the claims. Further, all of the components/structures described in the embodiments are not necessarily indispensable as means for solving the problem. For clarifying the explanation, the following description and the drawings are partially omitted and simplified as appropriate. The same symbols are assigned to the same elements throughout the drawings and duplicated explanations are omitted as appropriate.

### First Embodiment

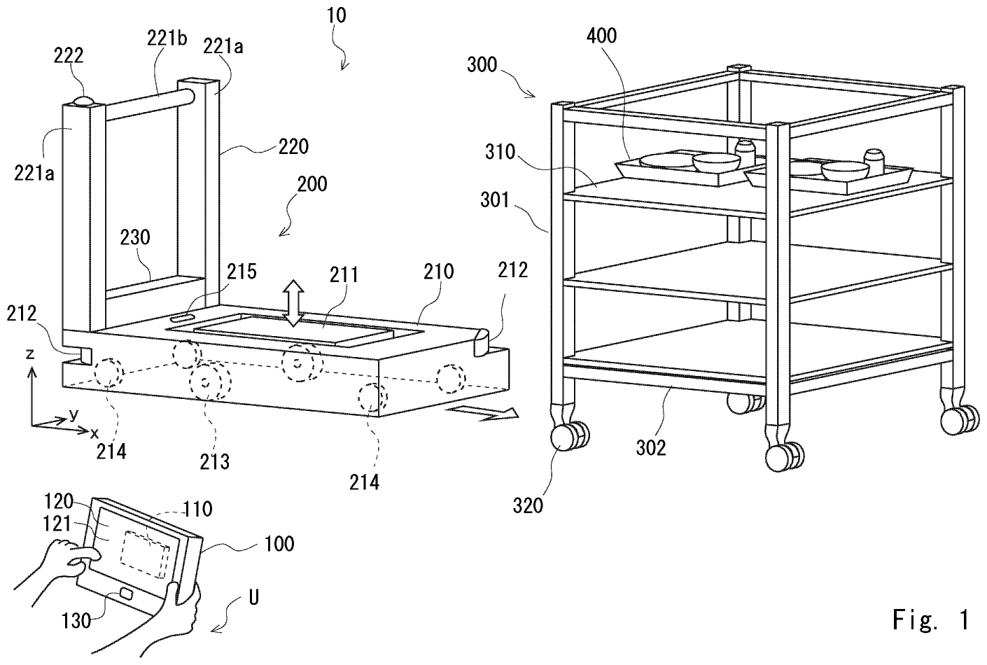

Referring to FIG. 1, a conveyance system according to a first embodiment will be described. In the conveyance system, a conveyance robot that autonomously moves in a predetermined area conveys a wagon that accommodates conveyed objects. FIG. 1 is an overview diagram of the conveyance system according to the first embodiment. A conveyance system 10 shown in FIG. 1 is one embodiment of the conveyance system. The conveyance system 10 is able to convey, for example, meal for patients from a kitchen, dishes after patients have finished eating to the kitchen, or clothes, bed linen or the like to a predetermined place in a facility such as a hospital. The conveyance system 10 includes, as its main components, an operation apparatus 100, a conveyance robot 200, and a wagon 300.

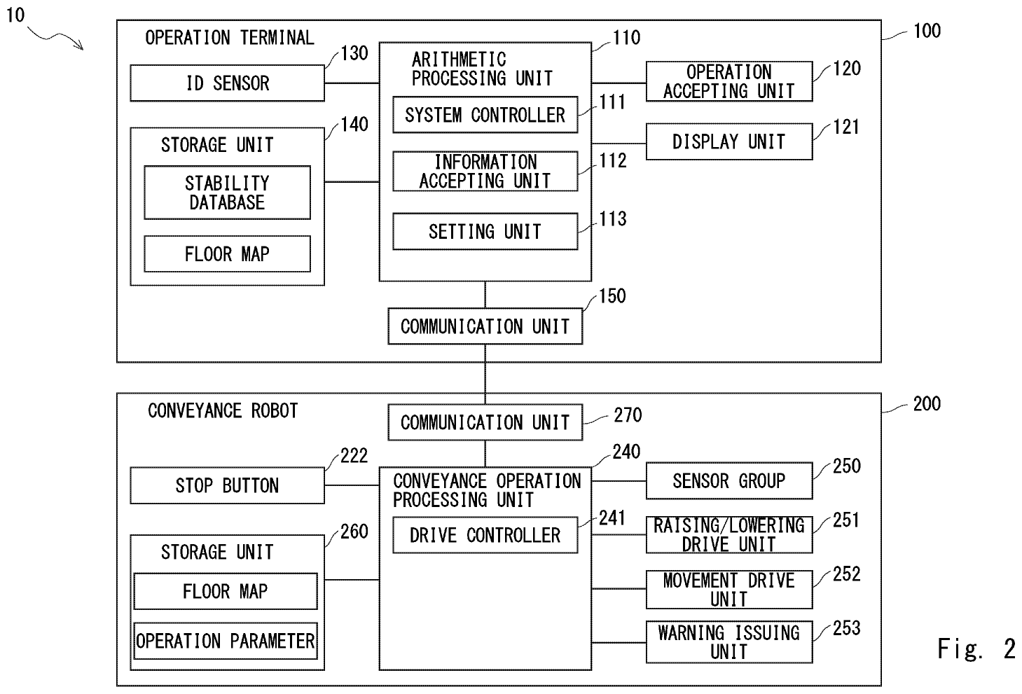

Note that in FIG. 1, a right-handed orthogonal coordinate system is shown for the sake of convenience for explaining a positional relation among components. Further, when an orthogonal coordinate system is shown in FIG. 2 and the following drawings, its X-, Y- and Z-axis directions coincide with the X-, Y- and Z-axis directions of the orthogonal coordinate system.

The operation apparatus 100, which is an apparatus that is connected to the conveyance robot 200 in such a way that they can communicate with each other wirelessly, is an apparatus for sending an instruction regarding various tasks to the conveyance robot 200. The operation apparatus 100, which is, for example, a tablet terminal, includes an arithmetic processing unit 110 and the like for controlling the entire conveyance system therein. The operation apparatus 100 further includes a display unit 121 for presenting various kinds of information to a user U and an operation accepting unit 120 which is a touch panel disposed over the display unit 121 and is an interface for allowing the user U to perform an operation.

An ID sensor 130 is provided in the vicinity of the display unit 121. The ID sensor 130, which is a sensor for identifying Identification (ID) of the user U who operates the conveyance robot 200, detects, for example, a unique identifier included in an ID card owned by each user U. The ID sensor 130 includes, for example, an antenna for reading information on a radio tag. The user U brings the ID card close to the ID sensor 130, thereby causing the conveyance robot 200 to recognize the ID of the user, who is an operator.

The conveyance robot 200 is an autonomous mobile robot that moves on the floor surface of the hospital. The conveyance robot 200 conveys the conveyed object accommodated in the wagon 300 from a predetermined position (starting point) to another position (destination). The conveyance robot 200 includes, as its main components, a main body block 210, a handle block 220, and a control block 230. In the following description, an operation in which the conveyance robot 200 moves from a predetermined place to the starting point, obtains the conveyed object, and conveys the conveyed object to the destination may be referred to as “recovering a conveyed object”.

The main body block 210 has a flat rectangular parallelepiped shape whose principal surface contacts the ground. The height of the principal surface of the main body block 210 is set to one that allows the main body block 210 to enter underneath the wagon 300. Thus the main body block 210 enters underneath the wagon 300 and raises the wagon 300 from below. The main body block 210 includes, as its main components, a raising/lowering unit 211, a distance measurement sensor 212, driving wheels 213, trailing wheels 214, and a speaker 215.

The raising/lowering unit 211, which is a flat-shaped component provided at the center of the upper surface of the main body block 210, includes a substantially smooth contact surface on the upper side (z-axis positive side) thereof. The contact surface is provided in such a way that it becomes parallel to the floor surface (xy plane) and is directed upward. A raising/lowering mechanism (not shown) for raising and/or lowering the raising/lowering unit 211 is provided in the lower side of the raising/lowering unit 211. With the raising/lowering mechanism, the raising/lowering unit 211 is able to raise and lower the contact surface and stop at a predetermined position. Thus the raising/lowering unit 211 is configured to contact the lower part of the wagon 300, raise the wagon 300 in parallel to the floor surface, and hold the wagon 300.

The distance measurement sensor 212 is a sensor that detects the conveyance robot 200 and an object which is in the vicinity of the conveyance robot 200 and is able to measure the distance from the object that has been detected. The distance measurement sensor 212 detects the relative position between the conveyance robot 200 and the object which is in the vicinity of the conveyance robot 200 by, for example, infrared light, laser light, millimeter waves or the like. The distance measurement sensor 212 may be referred to as an object sensor. The distance measurement sensor 212 is provided in each of the front part and the rear part of the main body block 210. Thus the distance measurement sensor 212 is able to detect an obstacle when there is an obstacle in a desired movement direction of the conveyance robot 200.

The conveyance robot 200 sets a safe distance regarding the distance between the obstacle detected by the distance measurement sensor 212 and the conveyance robot 200. The conveyance robot 200 controls the autonomous movement of the conveyance robot 200 in such a way that the distance between the obstacle and the conveyance robot 200 becomes larger than the safe distance. Further, when the distance between the obstacle and the conveyance robot 200 has become smaller than the safe distance, the conveyance robot 200 temporarily stops moving or issues a warning for an obstacle.

The driving wheels 213 contact the floor surface, support the main body block 210, and allow the main body block 210 to move. The main body block 210 includes two driving wheels 213 supported on one rotation axis extending in the right-left direction (y-axis direction) in such a way that they are separated from each other at the center of the conveyance robot 200 in the front-back direction (x-axis direction). The two driving wheels 213 are configured to be able to independently rotate about one rotation axis. The conveyance robot 200 moves forward or backward by driving the right and left driving wheels 213 at the same rotational speed and turns by driving the right and left driving wheels 213 at different rotational speeds or in different rotational directions.

The trailing wheels 214 contact the floor surface, support the main body block 210, and are freely rotated in accordance with the movement of the driving wheels 213. The main body block 210 includes the trailing wheels 214 in the front-back direction of the driving wheels 213. That is, the main body block 210 includes the trailing wheels 214 at four respective corners of the rectangular contact surface.

The speaker 215 is a component for emitting a preset voice. The speaker 215 is provided in such a way that the emitted voice can be recognized by passersby, etc. who are present in the vicinity of the conveyance robot 200. Thus the conveyance robot 200 is able to issue a warning such as calling attention to the presence of the conveyance robot 200 to the passersby, etc. via the speaker 215.

The handle block 220 is used when the user manually tows the conveyance robot 200. The handle block 220 includes two columnar members 221a that stand in parallel to each other with an interval therebetween in the right-left direction on the upper surface of a rear end part of the main body block 210 and a grip part 221b that bridges the upper end parts of the two respective columnar members 221a. A stop button 222 is provided in an upper end part of one of the two columnar members 221a. When the stop button 222 is pressed down, the conveyance robot 200 stops its autonomous movement.

The control block 230 includes a Central Processing Unit (CPU), a circuit and the like for controlling the drive of the conveyance robot 200. The control block 230 is placed in a desired position of the conveyance robot 200 and controls the conveyance robot 200 in accordance with an instruction received from the operation apparatus 100. Further, the control block 230 transmits information acquired from the sensor or the like of the conveyance robot 200 to the operation apparatus 100 as appropriate.

The conveyance robot 200 includes a posture sensor. The posture sensor, which is a six-axis sensor that is fixed in a desired position of the conveyance robot 200 and detects accelerations in the respective axis directions of the three orthogonal axes and angular velocities around the respective axes, detects a change in the posture of the conveyance robot 200. When, for example, the conveyance robot 200 passes a slope, the posture sensor detects the inclination of the conveyance robot 200 in accordance with the inclination on the floor surface.

The wagon 300 is a conveyed object accommodation body that accommodates a plurality of conveyed objects 400. The wagon 300 forms a frame body having a quadrangular prism shape since a plurality of frames 301 are coupled, and includes casters 320 provided in the four respective corners of the bottom surface part of the wagon 300.

In a place from the bottom surface part to a predetermined height, a bottom plate 302 is provided in parallel to the floor surface. The height from the floor surface to the lower surface of the bottom plate 302 is secured so that the main body block 210 of the conveyance robot 200 can enter the area between the floor surface and the lower surface of the bottom plate 302. The contact surface of the conveyance robot 200 contacts the lower surface of the bottom plate 302.

A plurality of shelf boards 310 are provided in parallel to the floor surface and in such a way that they are separated from one another inside the frame body of the wagon 300. The shelf boards 310 are configured in such a way that the conveyed object 400 is placed on the upper surface of each of the shelf boards 310. The conveyed object 400 is, for example, a tray that enables a patient of the hospital to have a meal, and includes dishes placed on the tray. Further, the dishes may include food left over by the patient.

While the wagon 300 shown in FIG. 1 is configured to accommodate the aforementioned tray, the wagon 300 may have various configurations depending on the conveyed object to be accommodated. For example, the wagon 300 for accommodating the bed linen may have an upper side of the bottom plate 302 formed of a member having a basket shape or a bag shape in place of the shelf board 310. Further, the wagon 300 may have a configuration in which the operation apparatus 100 is fixed thereto. When the wagon 300 and the operation apparatus 100 are integrated with each other, the operation apparatus 100 is set so that it performs an operation on the fixed wagon 300. That is, the user U does not need to perform the operation of selecting the wagon 300. Thus the user is able to easily input information regarding the stability that corresponds to the wagon 300. Further, the wagon 300 may have a configuration in which it does not include the casters 320.

Referring next to FIG. 2, a system configuration of the conveyance system will be described. FIG. 2 is a block diagram of the conveyance system according to the first embodiment. In the conveyance system 10, the operation apparatus 100 and the conveyance robot 200 are connected to each other in such a way that they can communicate with each other.

The operation apparatus 100 includes, as its main components, an arithmetic processing unit 110, an operation accepting unit 120, a display unit 121, an ID sensor 130, a storage unit 140, and a communication unit 150.

The arithmetic processing unit 110 is an information processing apparatus including an arithmetic unit such as a Central Processing Unit (CPU). The arithmetic processing unit 110 includes hardware included in the arithmetic processing unit 110 and a program stored in the hardware. That is, the processing executed by the arithmetic processing unit 110 is implemented either by hardware or software. The arithmetic processing unit 110 includes a system controller 111, an information accepting unit 112, and a setting unit 113.

The system controller 111 receives information from each of the components of the operation apparatus 100 and sends various instructions to each of the components in response to the received information.

The information accepting unit 112 accepts the stability information input from the user. The “stability information” according to this embodiment is information indicating the stability of the conveyed object 400 in the conveyance state. The stability information is set by the user performing a predetermined input operation.

The setting unit 113 receives the stability information accepted by the information accepting unit 112 and refers to a stability database stored in the storage unit 140 to set the operation parameter of the conveyance robot in a drive controller 241. The operation parameter of the conveyance robot is, for example, an acceleration when the raising/lowering unit 211 is driven, an acceleration or a maximum speed when the driving wheels 213 are driven or the like.

The operation accepting unit 120 accepts the input operation from the user and transmits an operation signal to the arithmetic processing unit 110. As means for accepting the input operation from the user, the operation accepting unit 120 includes a touch panel disposed over the display unit 121. The operation accepting unit 120 may include, in place of the touch panel or besides the touch panel, operation means such as a button or a lever. The user U turns on/off a power supply and/or performs an operation of inputting various tasks by operating the above-described input operation means.

The display unit 121 is a display unit including, for example, a liquid crystal panel and displays various kinds of information regarding the conveyance system 10. The display unit 121 is provided with a touch panel that accepts an operation from the user U and displays the content in conjunction with the touch panel.

The ID sensor 130 is connected to the arithmetic processing unit 110 and supplies information regarding the detected ID to the arithmetic processing unit 110.

The storage unit 140, which includes a nonvolatile memory such as a flash memory or a Solid State Drive (SSD), stores, for example, a stability database and a floor map. The storage unit 140 is connected to the arithmetic processing unit 110 and supplies the stored information to the arithmetic processing unit 110 in accordance with a request from the arithmetic processing unit 110. The stability database is information in which the information regarding the stability of the conveyed object 400 is associated with the operation parameter of the conveyance robot 200. The details of the stability database will be described later. The floor map is a map of the facility that the conveyance robot 200 uses for its autonomous movement. The floor map includes information on areas that are candidates for a route through which the conveyance robot 200 autonomously moves, information on the place where the wagon 300 is placed and the place to which the wagon 300 is to be delivered and the like.

The communication unit 150, which is an interface through which it is connected to the conveyance robot 200 so that they can communicate with each other, includes, for example, an antenna, a circuit for modulating or demodulating a signal that is transmitted through the antenna and the like. The communication unit 150, which is connected to the arithmetic processing unit 110, supplies a predetermined signal received from the conveyance robot 200 to the arithmetic processing unit 110 by wireless communication. Further, the communication unit 150 transmits the predetermined signal received from the arithmetic processing unit 110 to the conveyance robot 200.

The conveyance robot 200 includes a stop button 222, a conveyance operation processing unit 240, a group of sensors (hereinafter referred to as a sensor group) 250, a raising/lowering drive unit 251, a movement drive unit 252, a warning issuing unit 253, a storage unit 260, and a communication unit 270.

The stop button 222, which is connected to the conveyance operation processing unit 240, supplies a signal when the stop button is pressed to the conveyance operation processing unit 240.

The conveyance operation processing unit 240, which is an information processing apparatus including an arithmetic unit such as a CPU, acquires information from the respective components of the conveyance robot 200 and sends instructions to the respective components. The conveyance operation processing unit 240 includes a drive controller 241. The drive controller 241 controls operations of the raising/lowering drive unit 251, the movement drive unit 252, and the warning issuing unit 253. When the drive controller 241 has received the information regarding the operation parameter from the setting unit 113, the drive controller 241 performs processing of controlling the raising/lowering drive unit 251, the movement drive unit 252, and the warning issuing unit 253 in accordance with the received information.

The sensor group 250, which is a general term for various sensors included in the conveyance robot 200, includes the distance measurement sensor 212 and the posture sensor. The sensor group 250 is connected to the conveyance operation processing unit 240 and supplies the detected signal to the conveyance operation processing unit 240. The sensor group 250 may include, for example, besides the distance measurement sensor 212, a position sensor provided in the raising/lowering unit 211, a rotary encoder provided in the driving wheels 213 or the like. Further, the sensor group 250 may include, for example, besides the aforementioned sensors, a posture sensor configured to detect the inclination of the main body block 210.

The raising/lowering drive unit 251 includes a motor driver for driving the raising/lowering unit 211. The raising/lowering drive unit 251 is connected to the conveyance operation processing unit 240 and is driven upon receiving an instruction from the drive controller 241. The instruction from the drive controller 241 includes, for example, a signal for specifying the operation acceleration of the motor.

The movement drive unit 252 includes a motor driver for driving each of the two driving wheels 213. The movement drive unit 252 is connected to the conveyance operation processing unit 240 and is driven upon receiving an instruction from the drive controller 241. The instruction from the drive controller 241 includes, for example, a signal for specifying the operation acceleration of the motor (moving acceleration of the conveyance robot 200).

The warning issuing unit 253, which is a notification apparatus for issuing a warning to passersby, etc. who are present in the vicinity of the conveyance robot 200 via the speaker 215, includes a driver that drives the speaker 215. The warning issuing unit 253 is connected to the conveyance operation processing unit 240 and is driven upon receiving an instruction from the drive controller 241. The instruction from the drive controller 241 includes, for example, a signal for specifying the volume (notification level) when a warning is issued.

The storage unit 260 includes a nonvolatile memory and stores the floor map and the operation parameter. The floor map, which is a database that is necessary for the conveyance robot 200 to autonomously move, includes information that is the same as at least a part of the floor map stored in the storage unit 140 of the operation apparatus 100. The operation parameter includes information for instructing, when the conveyance robot 200 has received an instruction regarding the operation parameter from the operation apparatus 100, each of the components to perform an operation in accordance with the received instruction.

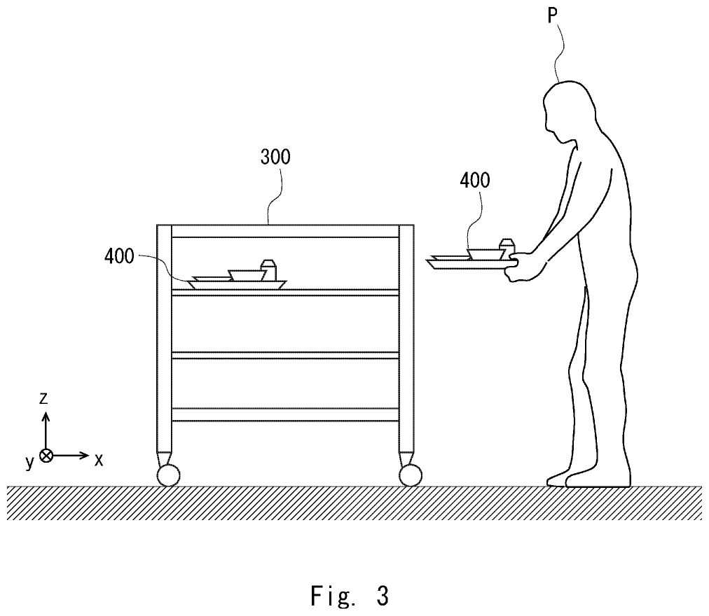

Referring next to FIGS. 3-6, one example of the operation in which the conveyance robot 200 conveys the wagon 300 will be described. The wagon 300 described here accommodates clearing trays (trays after the meals thereon have been eaten) after inpatients staying in the hospital have had a meal. The conveyance robot 200 executes a task of conveying the wagon 300 which accommodates the clearing trays.

FIG. 3 is a first diagram showing an example in which the conveyance system is used. The wagon 300 is placed in the vicinity of a hospital room in the hospital where an inpatient stays. The position where the wagon 300 is placed is predetermined and the conveyance robot 200 is able to move to an area in the vicinity of the wagon 300 by its autonomous movement. For example, an inpatient P stores the clearing tray, which is the conveyed object 400, in the wagon 300. After the clearing tray is accommodated in the wagon 300, the user U who is able to operate the operation apparatus 100 of the conveyance system 10 operates the operation apparatus 100 and inputs a task for conveying the wagon 300. Upon receiving an instruction from the operation apparatus 100, the conveyance robot 200 starts moving from a predetermined place where it has waited to the place where the wagon 300 is present.

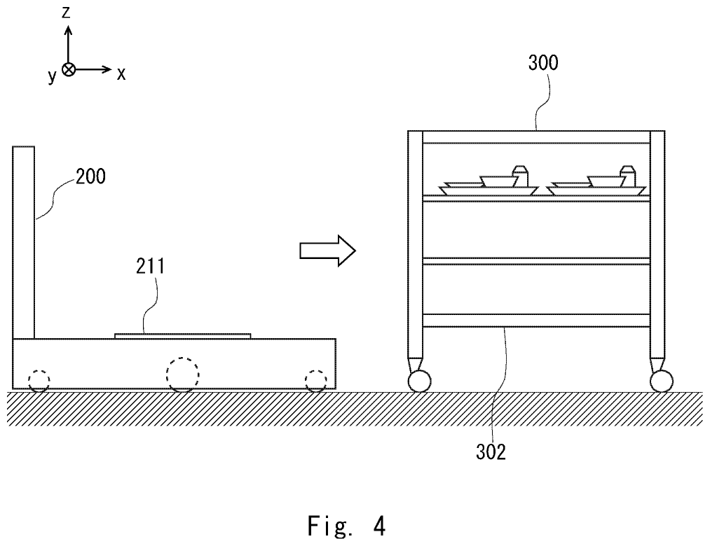

FIG. 4 is a second diagram showing an example in which the conveyance system 10 is used. FIG. 4 shows a state in which the conveyance robot 200 that has moved from a predetermined place to the place where the wagon 300 is present is approaching the wagon 300 in order to convey the wagon 300. The conveyance robot 200 enters underneath the wagon 300 from the front part. At this time, the raising/lowering unit 211 is set in a position lower than the bottom plate 302 of the wagon 300.

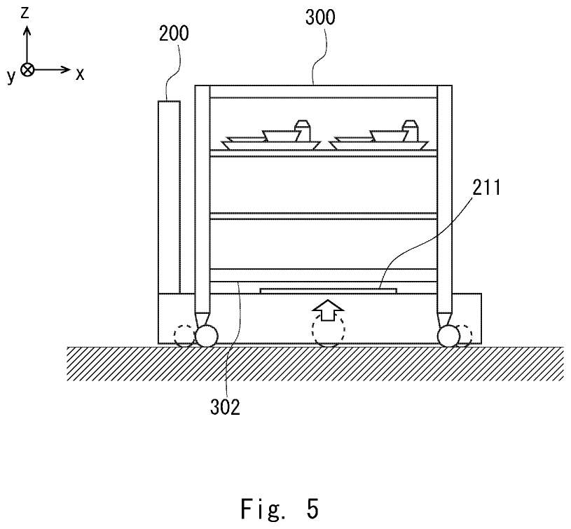

FIG. 5 is a third diagram showing an example in which the conveyance system is used. The conveyance robot 200 temporarily stops at a place where the raising/lowering unit 211 is positioned in the vicinity of the center of the wagon 300. Next, the conveyance robot 200 performs an operation of raising the raising/lowering unit 211 to cause the raising/lowering unit 211 to contact the bottom plate 302, thereby raising the wagon 300.

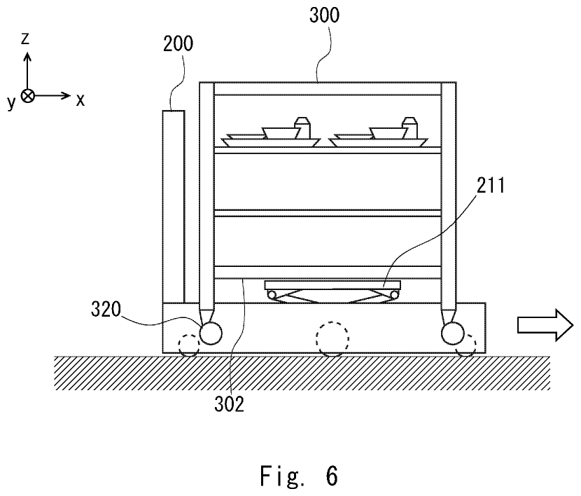

FIG. 6 is a fourth diagram showing an example in which the conveyance system is used. FIG. 6 shows a state in which the conveyance robot 200 lifts the wagon 300 since the raising/lowering unit 211 is raised. The raising/lowering unit 211 stops at the position shown in FIG. 6. Thus the casters 320 of the wagon 300 are lift up from the floor surface. In this way, the conveyance robot 200 conveys the wagon 300 that accommodates the conveyed objects 400 to the destination while maintaining the state in which the conveyance robot 200 lifts the wagon 300 from the floor surface.

The conveyance robot 200 conveys the wagon 300 by the aforementioned operations. The conveyed object 400 accommodated in the wagon 300 is subject to an impact associated with the raising/lowering operation when the wagon 300 is raised by the conveyance robot 200. Further, when the conveyance robot 200 moves on the floor, an external force such as an impact or a vibration is applied to the conveyed object 400 due to an acceleration, a deceleration, and a turn performed by the conveyance robot 200 or when the conveyance robot 200 moves over steps on the floor surface. When a dish on the meal tray falls or food that remains on the dish is spilt due to the application of the external force, it is possible that the wagon 300, the conveyance robot 200, and even the floor surface may be contaminated by the spilt food.

Therefore, when an unstable meal tray is conveyed at the time of conveyance, it is required to reduce the external force that the meal tray receives and prevent food from being spilt by relatively reducing the acceleration of the conveyance robot 200. In order to achieve this operation, the conveyance system 10 according to this embodiment is configured to set the operation parameter of the conveyance robot 200 by the user U inputting information regarding stability of the conveyed object 400.

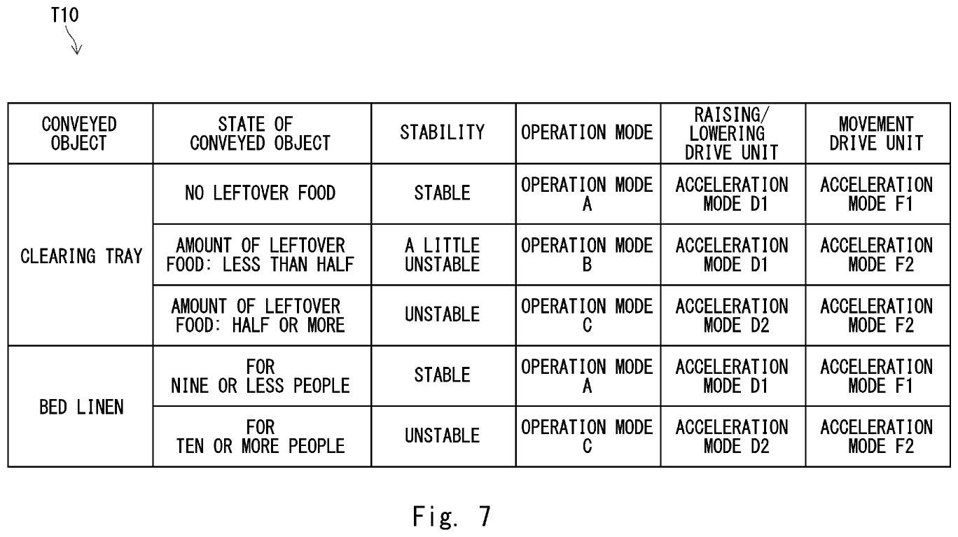

Referring to FIG. 7, a relation between the information regarding the stability of the conveyed object 400 and the operation parameter of the conveyance robot 200 will be described. FIG. 7 is a table showing an example of the database regarding the stability. A table T10 shown in FIG. 7 is one example of the stability database stored in the storage unit 140 of the operation apparatus 100.

The table T10 shows conveyed objects in the left column. The conveyed objects are “clearing tray” and “bed linen” from the top to the bottom. This indicates that the conveyance robot 200 conveys the clearing tray or the bed linen.

The right column of the conveyed objects shows states of the conveyed objects. The states of the conveyed objects show, regarding items that correspond to the “clearing tray”, “no leftover food”, “amount of leftover food: less than half”, and “amount of leftover food: half or more”, from the top to the bottom. Further, just below the above items, items that correspond to “bed linen”: “for nine or less people” and “for ten or more people”, are shown from the top to the bottom.

The right column of the states of the conveyed objects shows stabilities that correspond to the states of the conveyed objects. The stabilities are indicated by three items: “stable”, “a little unstable”, and “unstable”. That is, the states of the conveyed objects are classified into these three states.

The right column of the stabilities shows operation modes that correspond to the states of the conveyed objects. The operation modes are indicated by three items: an “operation mode A”, an “operation mode B”, and an “operation mode C”.

The right column of the operation modes shows the acceleration modes of the raising/lowering drive unit 251 that correspond to the respective operation modes by an “acceleration mode D1” and an “acceleration mode D2”. The “acceleration mode D1” and the “acceleration mode D2” are defined in such a way that the raising/lowering acceleration when the raising/lowering unit 211 is raised/lowered becomes a predetermined value. The maximum acceleration of the acceleration mode D2 is set to be smaller than the maximum acceleration of the acceleration mode D1. That is, when the acceleration mode D2 has been selected as the operation parameter of the raising/lowering drive unit 251, the raising/lowering unit 211 is operated at a speed relatively slower than that in the case in which the acceleration mode D1 has been selected.

Likewise, the right column of the acceleration modes of the raising/lowering drive unit indicates the acceleration modes of the movement drive unit 252 that correspond to the respective operation modes by an “acceleration mode F1” and an “acceleration mode F2”. The “acceleration mode F1” and the “acceleration mode F2” are each defined in such a way that the moving acceleration of the conveyance robot 200 due to the rotation of the driving wheels 213 becomes a predetermined value. The maximum acceleration of the acceleration mode F2 is set to be smaller than the maximum acceleration of the acceleration mode F1. That is, when the acceleration mode F2 has been selected as the operation parameter of the movement drive unit 252, the driving wheels 213 are operated at a speed relatively slower than that in the case in which the acceleration mode F1 has been selected.

According to the database shown in the aforementioned table T10, when the conveyance robot 200 conveys the clearing trays, the stability is classified into three stages depending on the amount of leftover food that remains in each of the clearing trays. In the case of “no leftover food”, the conveyed object is classified into “stable” and the operation mode A is selected as the operation parameter of the conveyance robot 200. In the operation mode A, the raising/lowering drive unit is in the acceleration mode D1 and the movement drive unit 252 is in the acceleration mode F1. In the case of “amount of leftover food: less than half”, the conveyed object is classified into “a little unstable” and the operation mode B is selected as the operation parameter of the conveyance robot 200. In the operation mode B, the raising/lowering drive unit is in the acceleration mode D1 and the movement drive unit 252 is in the acceleration mode F2. In the case of “amount of leftover food: half or more”, the conveyed object is classified into “unstable” and the operation mode C is selected as the operation parameter of the conveyance robot 200. In the operation mode C, the raising/lowering drive unit is in the acceleration mode D2 and the movement drive unit 252 is in the acceleration mode F2.

Likewise, according to the database indicated in the aforementioned table T10, when the conveyance robot 200 conveys the bed linen, the stability is classified into two stages depending on the amount of bed linen to be accommodated. In the case of “for nine or less people”, the conveyed object is classified into “stable” and the operation mode A is selected as the operation parameter of the conveyance robot 200. In the case of “for ten or more people”, the conveyed object is classified into “unstable” and the operation mode C is selected as the operation parameter of the conveyance robot 200.

The conveyance system 10 encourages the user U to input information regarding the stability in accordance with the items indicated in the aforementioned table T10.

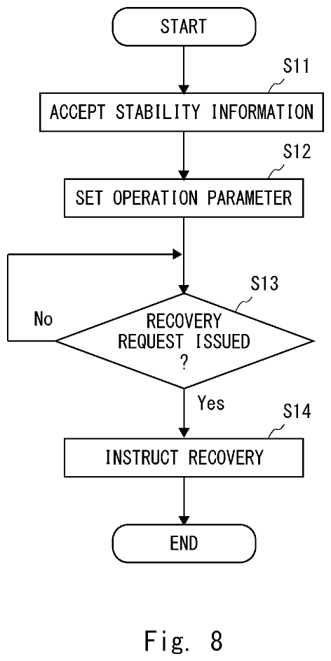

Referring next to FIG. 8, processing performed by the conveyance system 10 will be described. FIG. 8 is a flowchart showing processing of the conveyance system. The flowchart shown in FIG. 8 is the one that indicates processing performed by the arithmetic processing unit 110 of the operation apparatus 100.

First, the arithmetic processing unit 110 accepts the stability information (Step S11). Specifically, the arithmetic processing unit 110 causes the display unit 121 to display the screen for causing the user U to input the stability information. Then the arithmetic processing unit 110 accepts the stability information input by the user U.

Next, the arithmetic processing unit 110 sets the operation parameter in accordance with the accepted stability information (Step S12). The arithmetic processing unit 110 determines the operation parameter that corresponds to the stability information input by the user U by referring to the stability database in the storage unit 140.

Next, the arithmetic processing unit 110 determines whether or not a recovery request has been issued (Step S13). The “recovery request” is a command for requesting execution of a task for causing the conveyance robot 200 to convey the wagon 300 that accommodates the conveyed object 400. The recovery request is issued by an operation performed by the user U. When it is not determined that the recovery request has been issued (Step S13: No), the arithmetic processing unit 110 repeats Step S13. The arithmetic processing unit 110 may set a timer and perform processing to go back to Step S11 after a predetermined period of time has passed.

When it is determined that the recovery request has been issued (Step S13: Yes), the arithmetic processing unit 110 proceeds to Step S14. In Step S14, the arithmetic processing unit 110 sends an instruction for recovery to the conveyance robot 200 (Step S14).

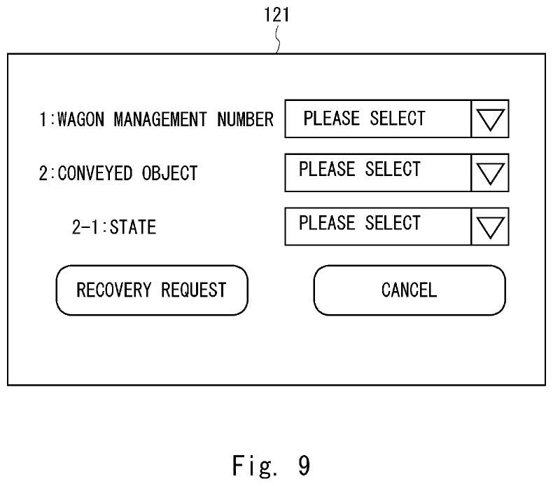

Referring next to FIGS. 9-11, examples of the display unit 121 when the stability information is accepted will be described. FIG. 9 is a first diagram showing an example of the operation screen of the operation apparatus 100. The display unit 121 displays, from the top to the bottom, “1: wagon management number”, “2: conveyed object”, and “2-1: state”, and the right side of each of these items shows a selection frame set so as to be selectable along with the message “please select”. The user touches the selection frame, thereby causing selection items to be displayed.

In “1: wagon management number”, the user U selects the management number of the wagon 300 that accommodates the clearing tray in the column of the wagon management number. The wagon management number is associated with the place where the wagon 300 is placed. Thus the management number of the wagon 300 is specified, which enables the conveyance robot 200 to specify the place that the conveyance robot 200 goes for the recovery. In “2: conveyed object”, the user U selects the conveyed object indicated in the table T10, i.e., “clearing tray” or “bed linen”. In “2-1: state”, the user U selects, for example, “state of conveyed object” indicated in the table T10.

The lower stage of the display unit 121 shows a button displayed as “recovery request” and a button displayed as “cancel”. The user U is able to press the “recovery request” button by selecting all the aforementioned selection items. When the “recovery request” button is pressed, an instruction for conveying the wagon 300 is sent from the operation apparatus 100 to the conveyance robot 200.

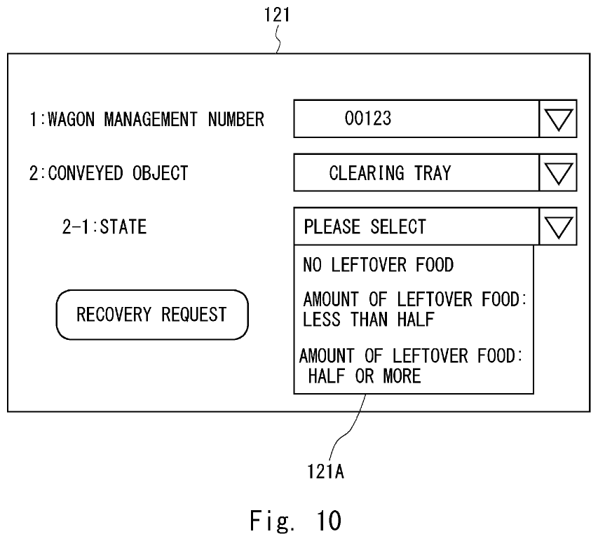

FIG. 10 is a second diagram showing an example of the operation screen of the operation apparatus. The example of the display unit 121 shown in FIG. 10 shows a state in which the user selects the state of the conveyed object. In FIG. 10, a selection column 121A of “2-1: state” shows items indicated as “no leftover food”, “amount of leftover food: less than half”, and “amount of leftover food: half or more”. These items indicate the “state of conveyed object” in the table T10 shown in FIG. 7. The user U recognizes the state of the leftover food by visually recognizing the accommodated clearing tray and selects one of the items in the selection column 121A. As described above, by causing the user U to select information associated with the stability at the time of conveyance, the conveyance system 10 is able to easily determine the operation parameter of the conveyance robot 200.

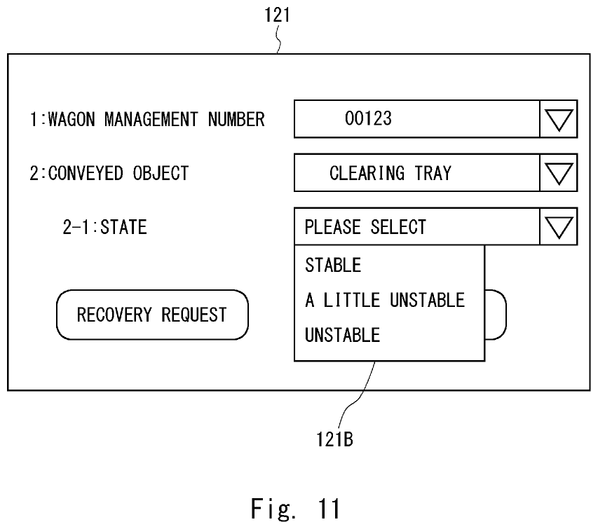

FIG. 11 shows another example in the selection items of the state of the conveyed object. FIG. 11 is a third diagram showing an example of the operation screen of the operation apparatus. The example shown in FIG. 11 is different from the example shown in FIG. 10 in that whether or not the state of the conveyed object is stable is selected by the user U. The display unit 121 shown in FIG. 11 displays “stable”, “a little unstable”, and “unstable” in a selection column 121B of “2-1: state”. These items show the “stability” in the table T10 shown in FIG. 7. The user U visually recognizes the accommodated clearing tray and selects one of the items regardless of the state of the leftover food. As described above, the stability at the time of conveyance is selected by the user U, whereby the conveyance system 10 is able to determine the operation parameter of the conveyance robot 200 even in a case in which it is difficult to make a quantitative determination.

While the first embodiment has been described above, the conveyance system 10 according to the first embodiment is not limited to have the aforementioned configuration. For example, as the operation parameter, it is sufficient that at least one of the parameters related to the conveyance operation of the conveyance robot 200 be included. Therefore, the operation parameter may be only the acceleration of the raising/lowering drive unit 251 or may be only the acceleration of the movement drive unit 252.

Further, the operation parameter is not limited to the aforementioned items. The operation parameter may be, for example, a moving path of the conveyance robot 200. In this case, the floor map stored in the storage unit 140 and the storage unit 260 includes a plurality of pieces of information on the path through which the conveyed object 400 is conveyed to the destination. The information on the path includes information regarding steps and slopes on the floor surface. In the stability database, the operation parameter is associated so that a path in which the steps and slopes on the floor surface are small can be selected when the stability shows unstable. With this configuration, the conveyance system 10 is able to select a suitable conveyance path in accordance with the stability information input from the user U.

The operation parameter may be the volume of the speaker 215 set in the warning issuing unit 253. In this case, the volume of the warning when a relatively unstable conveyed object is conveyed is set to be larger than the volume of the warning when a relatively stable conveyed object is conveyed. With this configuration, when a relatively unstable conveyed object is conveyed, it is possible to call attention to surrounding passersby, etc. who are present in a relatively wide range. Therefore, the conveyance system 10 is able to prevent a situation in which the passersby, etc. unexpectedly contact the conveyance robot 200 and to prevent collapse of the conveyed object and the like.

Further, the operation parameter may be, besides the ones described above, a range of detecting a safe distance from the obstacle detected by the distance measurement sensor 212. That is, the safe distance when a relatively unstable conveyed object is conveyed is set to be longer than the safe distance when a relatively stable conveyed object is conveyed. Thus, when a relatively unstable conveyed object is conveyed, a safe distance can be secured with respect to surrounding obstacles in a relatively wide range. Therefore, the conveyance system 10 is able to prevent a situation in which an obstacle unexpectedly contacts the conveyance robot 200 and to prevent collapse of the conveyed object and the like.

Further, the conveyance robot included in the conveyance system is not limited to have the aforementioned configuration. For example, the conveyance robot may include a configuration in which it tows the wagon instead of raising the wagon by the raising/lowering unit and conveying the wagon. Further, the conveyance robot may include an accommodation room that accommodates the conveyed object and convey the conveyed object while directly accommodating the conveyed object. In this case, the conveyance robot that includes the accommodation room may have a configuration in which it includes an operation unit with which the operation apparatus is integrated. When this configuration is employed, the user stores the conveyed object in the accommodation room of the conveyance robot and inputs information regarding the stability of the conveyed object that has been accommodated through the operation unit that is integrated with the conveyance robot.

As described above, according to the first embodiment, it is possible to provide a conveyance system and the like capable of preferably conveying the conveyed object.

### Second Embodiment

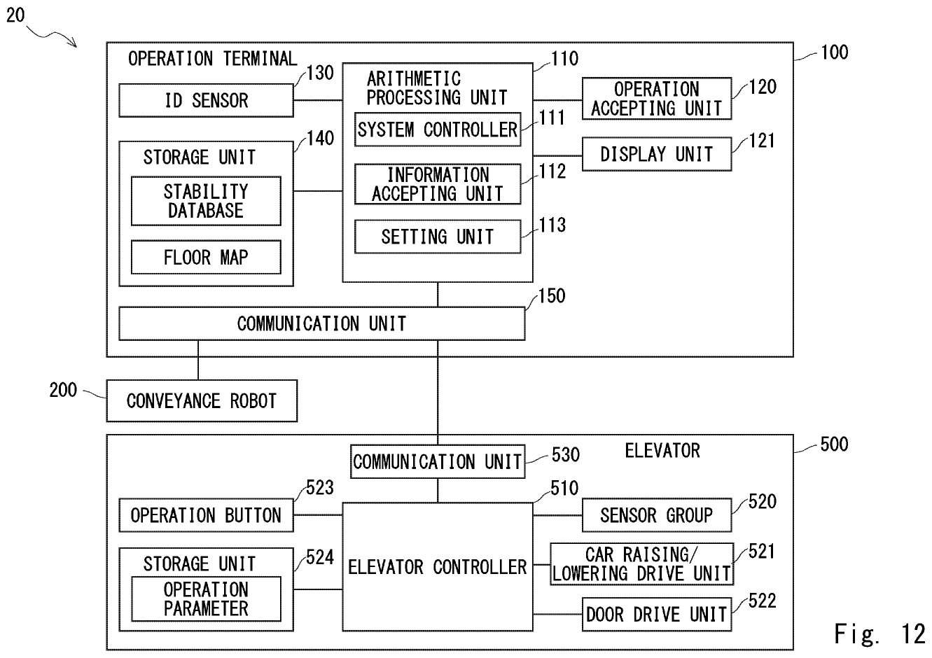

Referring next to FIG. 12, a second embodiment will be described. A conveyance system according to the second embodiment is different from that of the first embodiment in that the operation apparatus 100 is connected also to an elevator 500 in such a way that they can communicate with each other. FIG. 12 is a block diagram of the conveyance system according to the second embodiment. A conveyance system 20 shown in FIG. 12 includes an operation apparatus 100, a conveyance robot 200, and the elevator 500. The elevator 500 is installed in a facility where the conveyance robot 200 autonomously moves. The conveyance robot 200 moves across floors of the facility using the elevator 500.

The communication unit 150 of the operation apparatus 100 according to the second embodiment is connected not only to the conveyance robot 200 but also to the elevator 500 in such a way that they can communicate with each other wirelessly. Further, the stability database stored in the storage unit 140 stores information related to an operation parameter of the elevator 500. The setting unit 113 of the arithmetic processing unit 110 receives the stability information accepted by the information accepting unit 112 and refers to the stability database stored in the storage unit 140, thereby setting the operation parameter of the elevator 500.

The elevator 500 includes an elevator controller 510, a sensor group 520, a car raising/lowering drive unit 521, a door drive unit 522, an operation button 523, a storage unit 524, and a communication unit 530. The elevator controller 510, which is connected to the respective components of the elevator, controls various operations performed by the elevator. The sensor group 520 include a door sensor of the elevator, a position sensor of the car and the like. The car raising/lowering drive unit 521 has a function of driving the raising/lowering operation of the car included in the elevator 500. The door drive unit 522 drives the opening/closing operation of the door in a state in which the car of the elevator 500 is stopped at a desired floor. The operation button 523 includes destination buttons of the elevator provided in the car. The storage unit 524 includes a nonvolatile memory and stores the operation parameter. The operation parameter includes information for instructing, when the elevator 500 receives an instruction regarding the operation parameter from the operation apparatus 100, each of the components to perform the operation in accordance with the received instruction.

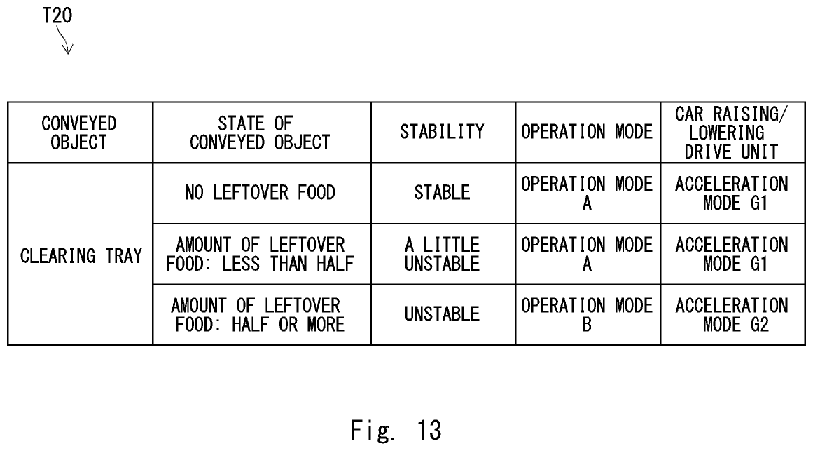

FIG. 13 is a table showing an example of the stability database according to the second embodiment. A table T20 shown in FIG. 13 is one example of the stability database stored in the storage unit 140 of the operation apparatus 100. The table T20 in FIG. 13 shows a case in which the conveyed object is a clearing tray as one example.

The right column of the operation modes shown in the display T20 shows acceleration modes of the car raising/lowering drive unit 521 of the elevator 500 that correspond to the respective operation modes by an “acceleration mode G1” and an “acceleration mode G2”. The maximum acceleration in the acceleration mode G2 is set to be smaller than that in the acceleration mode G1. That is, in the elevator 500, the speed of the raising/lowering operation of the car of the elevator 500 in the case in which the acceleration mode G2 is selected as the operation parameter of the car raising/lowering drive unit 521 becomes relatively slower than that in the case in which the acceleration mode G1 has been selected.

According to the database shown in the aforementioned table T20, when the conveyance robot 200 conveys the clearing trays, the stability is classified into three stages depending on the amount of leftover food that remains in each of the clearing trays. In the case of “no leftover food”, the conveyed object is classified into “stable” and the operation mode A is selected as the operation parameter of the elevator 500. The acceleration setting of the car raising/lowering drive unit 521 in the operation mode A is the acceleration mode G1. In the case of “amount of leftover food: less than half”, the conveyed object is classified into “a little unstable” and the operation mode A is selected as the operation parameter of the elevator 500. On the other hand, when “amount of leftover food: half or more”, the conveyed object is classified into “unstable” and the operation mode B is selected as the operation parameter of the elevator 500. The acceleration setting of the car raising/lowering drive unit 521 in the operation mode B is the acceleration mode G2.

While the second embodiment has been described above, the conveyance system 20 according to the second embodiment is not limited to have the aforementioned configuration. For example, the operation apparatus 100 of the conveyance system 20 may set, besides the operation parameter of the elevator 500, the operation parameter of the conveyance robot 200 as well. In this case, for example, the table T20 shown in FIG. 13 includes, besides the acceleration mode of the car raising/lowering drive unit 521, information for setting the operation parameter of the conveyance robot 200 indicated in the first embodiment.

As described above, according to the second embodiment, the conveyance apparatus for conveying the conveyed object is not limited to the conveyance robot 200 and it is possible to set the operation parameter of the elevator 500 which the conveyance robot 200 gets on. Therefore, according to the second embodiment, it is possible to provide a conveyance system and the like capable of comprehensively and preferably conveying the conveyed object.

The aforementioned program can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), Compact Disc Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.). The program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Note that the present disclosure is not limited to the aforementioned embodiments and may be changed as appropriate without departing from the spirit of the present disclosure. For example, while the system in which the conveyance robot autonomously moves in a hospital has been described in the aforementioned embodiments, the aforementioned system is able to convey predetermined objects as conveyed objects in a hotel, a restaurant, an office building, an event venue, or a complex facility.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A conveyance system comprising:
a conveyance apparatus for conveying a conveyed object;
a controller configured to control an operation of the conveyance apparatus;
an information accepting unit configured to accept an input from a user regarding stability information indicating stability of the conveyed object in a conveyance state; and
a setting unit configured to set an operation parameter of the conveyance apparatus in the controller based on the accepted stability information.

2. The conveyance system according to claim 1, wherein the information accepting unit presents options for causing a user to select the stability and accepts the option selected by the user as the input.

3. The conveyance system according to claim 1, wherein the conveyance apparatus is a conveyance robot that autonomously moves in a predetermined area.

4. The conveyance system according to claim 3, wherein the setting unit sets at least one of a moving acceleration of the conveyance robot and a moving path along which the conveyance robot passes as the operation parameter.

5. The conveyance system according to claim 3, wherein
the conveyance robot comprises an object sensor configured to detect an object that is present in the vicinity of the conveyance robot, and
the setting unit sets a range detected by the object sensor as the operation parameter.

6. The conveyance system according to claim 3, wherein
the conveyance robot comprises a notification apparatus that sends a notification indicating that the conveyance robot is conveying the conveyed object to an area in the vicinity of the conveyance robot, and
the setting unit sets a notification level of the notification apparatus as the operation parameter.

7. The conveyance system according to claim 3, wherein
the conveyance robot comprises a raising/lowering mechanism for raising and/or lowering a wagon that accommodates the conveyed object, and
the setting unit sets a raising/lowering acceleration of the raising/lowering mechanism as the operation parameter.

8. The conveyance system according to claim 7, wherein
the information accepting unit is provided in the wagon, and
the wagon transmits the accepted stability information to the setting unit.

9. The conveyance system according to claim 1, wherein
the conveyance apparatus is an elevator that raises and/or lowers a conveyance robot that conveys the conveyed object by an autonomous movement in a predetermined area, and
the setting unit sets a moving acceleration of the elevator as the operation parameter.

10. A conveyance method for controlling an operation of a conveyance apparatus for conveying a conveyed object, the method comprising:
an information accepting step for accepting an input from a user regarding stability information indicating stability of the conveyed object in a conveyance state;
a setting step for setting an operation parameter of the conveyance apparatus based on the accepted stability information; and
a control step for controlling the conveyance apparatus by the set operation parameter.

11. A computer readable non-transitory storage medium storing a program for causing a computer to execute a control method for controlling an operation of a conveyance apparatus for conveying a conveyed object, the program comprising:
an information accepting step for accepting an input from a user regarding stability information indicating stability of the conveyed object in a conveyance state;
a setting step for setting an operation parameter of the conveyance apparatus based on the accepted stability information; and
a control step for controlling the conveyance apparatus by the set operation parameter.
